(19) United States
(12) Patent Application Publication
(10) Pub. No.: US 2017/0080929 A1
(43) Pub. Date: Mar. 23, 2017

(54) MOVEMENT-ASSISTING DEVICE

(71) Applicant: HONDA MOTOR CO., LTD., MINATO-KU, TOKYO (JP)

(72) Inventor: Kiichiro SAWAMOTO, WAKO-SHI, SAITAMA-KEN (JP)

(73) Assignee: HONDA MOTOR CO., LTD., MINATO-KU, TOKYO (JP)

(21) Appl. No.: 15/310,890

(22) PCT Filed: Apr. 10, 2015
(86) PCT No.: PCT/JP2015/061217

§ 371 Date: Nov. 14, 2016

(30) Foreign Application Priority Data
May 15, 2014 (JP) 2014-101490

(51) Int. Cl. B60W 30/095; B60W 10/18; G08G 1/16; B60W 10/20; B60Q 9/00

(52) U.S. Cl. CPC B60W 30/0956; B60W 10/20; B60Q 9/008; G08G 1/166; B60W 10/18

(57) ABSTRACT

An assistive control means provided in a movement-assisting device has a probability determining unit for determining whether the detection probability according to a first detection signal is high, and a same-object-identifying unit for identifying whether other objects specified respectively by the first detection signal and a second detection signal are the same objects. The assistive control means controls the operation of an assistive means only when the detection probability is determined to be high and when the objects are identified as being the same object. Consequently, a behavior-stabilized assistive operation can be continued even if the detection probability of one of the detection signals is low when the other objects are detected on the basis of two types of detection signals.

### TECHNICAL FIELD

The present invention relates to a movement assisting device having an assisting unit for assisting movement by a physical object or a living body as a mobile object.

### BACKGROUND ART

Various technologies have been developed for detecting the peripheral state of a user's own vehicle (one form of a mobile object) using an external sensor, and detecting other physical objects on the basis of a signal obtained from the sensor.

Japanese Laid-Open Patent Publication No. 2005-239114 proposes an assisting device that performs traveling support for a user's own vehicle responsive to the detection result of another physical object, which is obtained using at least one of radar and image recognition. In particular, it is disclosed that control conditions are shifted to a suppression side, in an order in which the reliability of the detection result is high, and specifically, an order of “both”, “radar only”, and “image recognition only”.

### SUMMARY OF INVENTION

Incidentally, under a condition in which the SN ratio (Signal to Noise ratio) is small in a detection signal of either one of radar and image recognition, since a time fluctuation occurs in the detection result, there is a concern that detection accuracy will be lowered.

However, in accordance with the device disclosed in Japanese Laid-Open Patent Publication No. 2005-239114, if the detection process by either of the two types of detection signals is successful, the assisting operation is continued while the control conditions also are suppressed. In carrying out such an operation, cases occur in which the behavior of the assisting operation becomes unstable, and a feeling of discomfort may arise in those who are recipients of the assisting operation.

The present invention has been made with the aim of solving the aforementioned problem. An object of the present invention is to provide a movement assisting device in which it is possible to continue the assisting operation with stabilized behavior, even under a condition in which the detection reliability of one of the detection signals is low when other physical objects are detected based on the two types of detection signals.

A movement assisting device according to the present invention is a device including an assisting unit configured to assist movement of a physical object or a living body as a mobile object, comprising a first detecting member configured to acquire a first detection signal indicative of another physical object that exists in vicinity of the mobile object, a second detecting member configured to acquire a second detection signal indicative of the other physical object, and to use a same or a different detection system as the first detecting member, and an assistance control member configured to implement a process in the mobile object to cope with the other physical object, by controlling an assisting operation performed by the assisting unit based on the first detection signal and the second detection signal that are acquired respectively by the first detecting member and the second detecting member. The assistance control member includes an accuracy determining unit configured to determine whether or not detection accuracy in accordance with the first detection signal is high, and a same object identifying unit configured to identify whether or not the other physical objects specified respectively by the first detection signal and the second detection signal are the same object, wherein, in a case it is determined by the accuracy determining unit that the detection accuracy is not high, the assisting operation is controlled only if it is further identified by the same object identifying unit that the other physical objects are the same object.

In the foregoing manner, in the case it is determined by the determining unit that the detection accuracy by the first detection signal is not high, and furthermore, only in the case that the same object identifying unit identifies that the other physical objects specified by the first detection signal and the second detection signal are the same object, then the assisting operation is controlled by the assisting unit. Therefore, in a master-servant relationship in which the first detecting member is regarded as the main (primary determination) member and the second detecting member is regarded as the subordinate (secondary determination) member, the detection result of the other physical object can be determined in a multilateral and complementary manner. Consequently, in the case that the other physical object is detected based on the two types of detection signals, it is possible to continue the assisting operation with stabilized behavior, even under a condition in which the detection reliability of one of the detection signals is low.

Further, the accuracy determining unit is preferably configured to determine that the detection accuracy is high if an intensity of the first detection signal is greater than a threshold value, and determine that the detection accuracy is not high if the intensity of the first detection signal is less than or equal to the threshold value. Even if the detection accuracy is determined erroneously to be high due to noise components of a degree that cannot be ignored being mixed within the first detection signal, since it is identified by the same object identifying unit that the objects are not the same, starting and continuation of the assisting operation due to false positives can be prevented.

Further, the accuracy determining unit is preferably configured to determine that the detection accuracy is high if an amount of data or an amount of computational processing of the first detection signal is more than a threshold value, and determine that the detection accuracy is not high if the amount of data or the amount of computational processing of the first detection signal is less than or equal to the threshold value. By this feature, a trend is suitably reflected in which the detection accuracy becomes higher the greater the amount of data or the amount of computational processing of the first detection signal.

Further, the accuracy determining unit is preferably configured to determine that the detection accuracy is high if a duration over which the other physical object is specified by the first detection signal is longer than a threshold value, and determine that the detection accuracy is not high if the duration over which the other physical object is specified by the first detection signal is less than or equal to the threshold value. By this feature, a trend is suitably reflected in which the detection accuracy becomes higher the longer the duration is, over which the other physical object is specified by the first detection signal.

Further, the accuracy determining unit is preferably configured to determine whether or not the detection accuracy is high on a basis of a correlation value between a pattern signal and the first detection signal or a time series of the first detection signal. For example, a trend can suitably be reflected in which the detection accuracy becomes low for cases in which the correlation value is high with a typical pattern signal that tends to result in erroneous detection.

Further, the first detecting member is preferably configured to employ a detection system in which a detection accuracy of a distance between the mobile object and the other physical object is higher, together with a detection upper limit value of the distance being greater than that of the second detecting member. More preferably, the first detecting member is constituted by a radar sensor, and the second detecting member is constituted by a camera.

According to the movement assisting device of the present invention, in the event it is determined by the determining unit that the detection accuracy by the first detection signal is not high, and furthermore, only in the case that the same object identifying unit identifies that the other physical objects specified by the first detection signal and the second detection signal are the same object, then the assisting operation is controlled by the assisting unit. Therefore, in a master-servant relationship in which the first detecting member is regarded as the main (primary determination) member and the second detecting member is regarded as the subordinate (secondary determination) member, the detection result of the other physical object can be determined in a multilateral and complementary manner. Consequently, in the case that the other physical object is detected based on the two types of detection signals, it is possible to continue the assisting operation with stabilized behavior, even under a condition in which the detection reliability of one of the detection signals is low.

### BRIEF DESCRIPTION OF DRAWINGS

FIG. 1 is a schematic block diagram showing a configuration of a movement assisting device according to an embodiment of the present invention;

FIG. 2 is a schematic perspective view of a user's own vehicle in which the movement assisting device shown in FIG. 1 is incorporated;

FIG. 3 is a flowchart for providing a description of operations of the movement assisting device shown in FIGS. 1 and 2;

FIG. 4 is a detailed flowchart in relation to a method of detecting other physical objects (step S3 of FIG. 3);

FIG. 5 is a first plan view showing a positional relationship between a user's own vehicle and another physical object;

FIG. 6 is a schematic diagram showing radiation angle characteristics of a first detection signal;

FIG. 7 is a schematic diagram showing a captured image in a second detection signal; and

FIG. 8 is a second plan view showing a positional relationship between a user's own vehicle and another physical object.

### DESCRIPTION OF EMBODIMENTS

A preferred embodiment of a movement assisting device according to the present invention will be described in detail below with reference to the accompanying drawings.

### [Configuration of Movement Assisting Device 10]

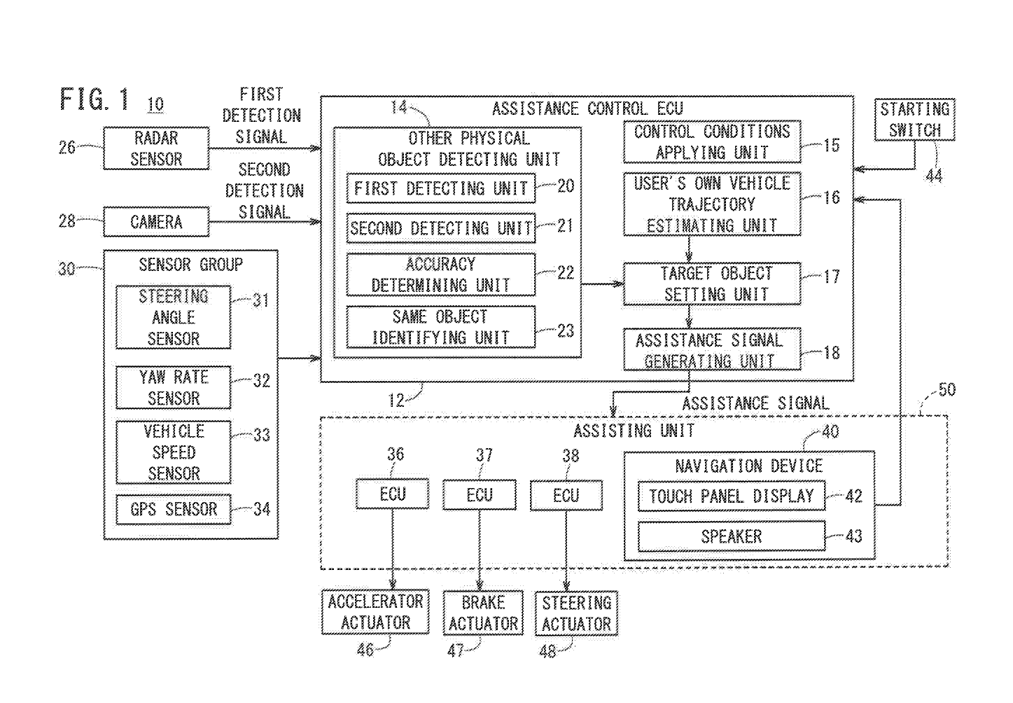

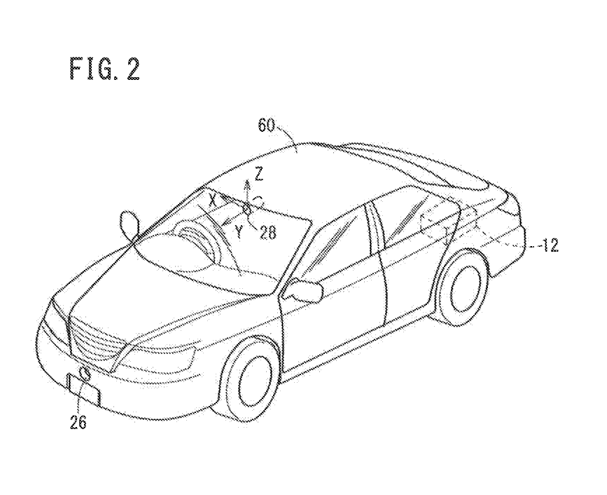

FIG. 1 is a schematic block diagram showing a configuration of a movement assisting device 10 according to the present embodiment. FIG. 2 is a schematic perspective view of a user's own vehicle 60 in which the movement assisting device 10 shown in FIG. 1 is incorporated.

The movement assisting device 10 is equipped with an electronic control unit (hereinafter referred to as an assistance control ECU 12 or an assistance control member) that executes various controls in order to assist the movement of the user's own vehicle 60 (see FIG. 2) which is one form of a mobile object. It should be noted that the term “assistance” as used in the present specification covers not only a situation of automatically driving the user's own vehicle 60, but also a situation of prompting the driver of the user's own vehicle 60 to undertake actions to move the user's own vehicle 60.

By reading out and executing programs from a non-illustrated memory, the assistance control ECU 12 is capable of implementing the respective functions of another physical object detecting unit 14, a control conditions applying unit 15, a user's own vehicle trajectory estimating unit 16, a target object setting unit 17, and an assistance signal generating unit 18. Further, the other physical object detecting unit 14 is constituted to include a first detecting unit 20, a second detecting unit 21, an accuracy determining unit 22, and a same object identifying unit 23. The specific functions of each of such components will be described later.

The movement assisting device 10 further comprises a radar sensor 26 (first detecting member) that transmits electromagnetic waves such as millimeter waves or the like toward the exterior of the user's own vehicle 60, and based on the reception characteristics of reflected waves, detects the positions of other physical objects, and a camera 28 (second detecting member) that acquires images including images of other physical objects that reside in the vicinity of the user's own vehicle 60.

As shown in FIG. 2, the radar sensor 26 is arranged as one unit on a front portion (for example, in the vicinity of the front grill) of the user's own vehicle 60. Further, the camera 28 is arranged as one unit on an upper portion of a front window shield of the user's own vehicle 60. On the camera 28, the mounting position thereof defines an origin point, and a real space coordinate system is defined with the vehicle transverse direction of the user's own vehicle 60 (horizontal direction) defining an X-axis, the vehicle axial direction (direction of travel) defining a Y-axis, and the vehicle height direction (vertical direction) defining a Z-axis.

The movement assisting device 10, in addition to the radar sensor 26 and the camera 28, is further equipped with a sensor group 30 made up from a plurality of sensors. The radar sensor 26, the camera 28, and each of the sensors constituting the sensor group 30 are connected electrically to the assistance control ECU 12.

The sensor group 30 includes a steering angle sensor 31 that detects an angle of rotation (steering angle) of a non-illustrated steering wheel, a yaw rate sensor 32 that detects a yaw rate of the user's own vehicle 60, a vehicle speed sensor 33 that detects the speed of the user's own vehicle 60, and a GPS (Global Positioning System) sensor 34 that detects the current position of the user's own vehicle 60. The configuration of the sensor group 30 is not limited to the illustrated example, and may comprise multiple sensors of the same type, as well as a detection member apart from those illustrated.

The movement assisting device 10 is further equipped with three ECUs 36, 37, 38, a navigation device 40 (including a touch panel display 42 and a speaker 43), and a starting switch 44. The starting switch 44 is a switch for initiating or stopping operation of the assistance control ECU 12.

An accelerator actuator 46 that operates a non-illustrated accelerator pedal is connected to the ECU 36, which administers a control in relation to an electric accelerator. A brake actuator 47 that operates a non-illustrated brake pedal is connected to the ECU 37, which administers a control in relation to an electric brake. A steering actuator 48 that operates a non-illustrated steering wheel is connected to the ECU 38, which administers a control in relation to an electric steering system.

The touch panel display 42 outputs visual information to the inside of a display screen, together with allowing input of various information by detecting touch positions on the display screen. Further, the speaker 43 outputs sound or voice information including warnings, voice guidance, and the like.

The assistance control ECU 12 generates and outputs control signals (hereinafter referred to as assistance signals) for implementing processes in the user's own vehicle 60 directed at other physical objects, and supplies assistance signals to an assisting unit 50. In the present illustrated example, the ECUs 36 to 38 and the navigation device 40 function as the assisting unit 50 for assisting the movements performed by the user's own vehicle 60.

### [Operations of Movement Assisting Device 10]

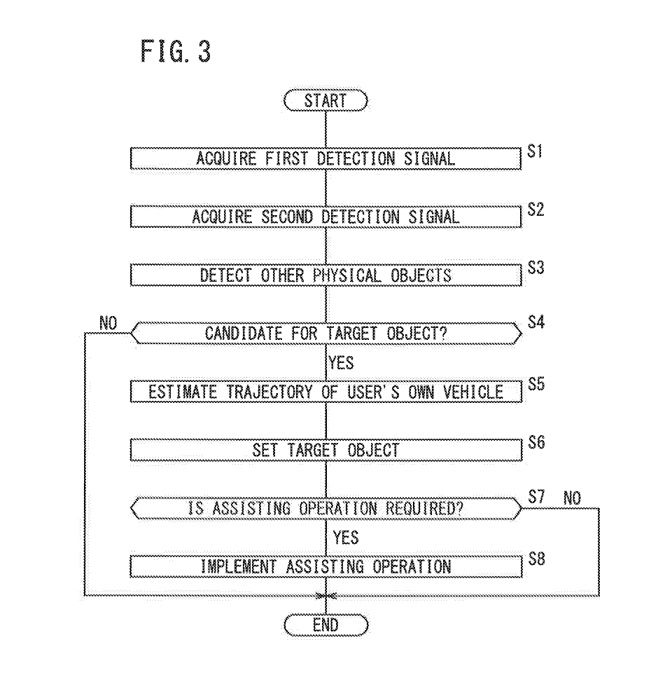

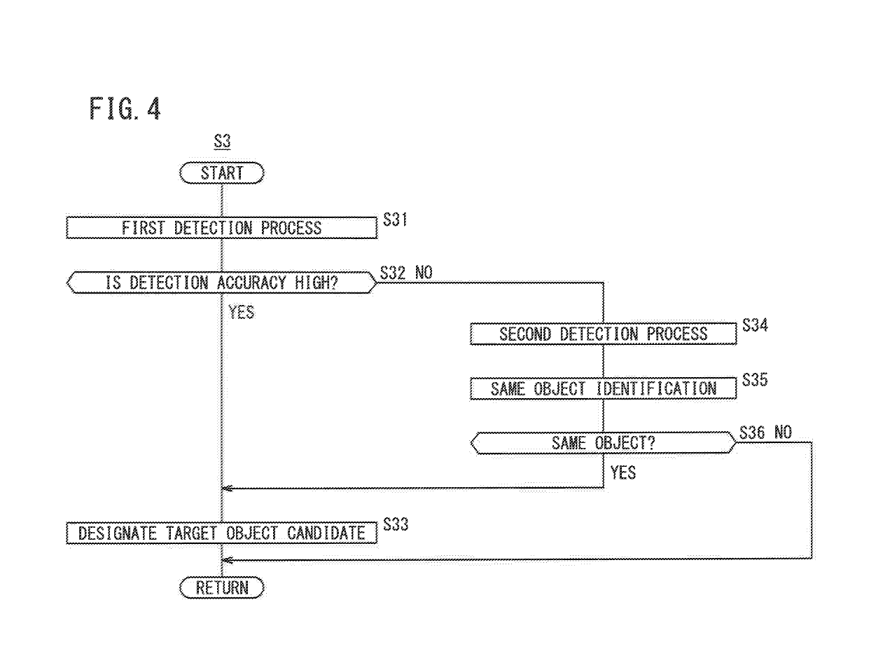

An operation sequence of the movement assisting device 10 shown in FIGS. 1 and 2 will be described below with reference to the flowcharts shown in FIGS. 3 and 4.

Prior to such operations, an occupant (in particular, the driver) of the user's own vehicle 60 performs a set operation in relation to the assisting operations. More specifically, the occupant places the starting switch 44 in an ON state, and inputs respective control information through the touch panel display 42 of the navigation device 40. Upon doing so, the control conditions applying unit 15 applies the control conditions including the types of assisting operations and control variables, whereby the operations of the assistance control ECU 12 are enabled, i.e., made “valid”.

In step S1, the radar sensor 26 detects the condition of the outside environment in the vicinity (primarily in the front) of the user's own vehicle 60, and thereby acquires first detection signals. Thereafter, the first detection signals are supplied sequentially from the radar sensor 26 to the assistance control ECU 12.

In step S2, the camera 28 detects the condition of the outside environment in the vicinity (primarily in the front) of the user's own vehicle 60, and thereby acquires second detection signals. Thereafter, the second detection signals are supplied sequentially from the camera 28 to the assistance control ECU 12.

In step S3, at a regular or irregular execution timing, the other physical object detecting unit 14 detects the presence or absence and type of other objects (i.e., other physical objects) that differ from the user's own vehicle 60. The types of other physical objects include, for example, human bodies, various animals (i.e., mammals such as deer, horses, sheep, dogs, cats, etc., birds, etc.) and artificial structures (i.e., mobile objects including vehicles, as well as markers, utility poles, guardrails, walls, etc.). Details of the detection process will be described later.

In step S4, the other physical object detecting unit 14, from among the one or more physical objects detected in step S3, determines whether or not any of them are candidates for target objects. In this instance, the term “target objects” implies other physical objects that become a target or aim of the assisting operations of the movement assisting device 10. If it is determined that no target object exists (step S4: NO), the movement assisting device 10 terminates the assisting operation for the corresponding execution timing. On the other hand, if it is determined that a target object candidate exists (step S4: YES), then the control proceeds to the next step (step S5).

In step S5, using a well-known type of estimating method, the user's own vehicle trajectory estimating unit 16 estimates the trajectory traveled by the user's own vehicle 60. As information that is subjected to the estimating process, for example, there may be cited the first detection signals, the second detection signals, various sensor signals indicative of the steering angle, the yaw rate, the speed, and the current position of the user's own vehicle 60, and map information acquired from the navigation device 40, etc.

In step S6, the target object setting unit 17 sets as a target object one from among the other physical objects that were determined to be candidates in step S5. For example, the target object setting unit 17 sets as a target object a physical object that lies within a predetermined range from the position of the user's own vehicle 60, and resides on the trajectory of the user's own vehicle 60. The target object setting unit 17 supplies to the assistance signal generating unit 18 information indicating the presence of the target object, together with detection results (i.e., position, speed, width, and attributes) thereof.

In step S7, the assistance control ECU 12 determines whether or not it is necessary to carry out an assisting operation of the user's own vehicle 60. If it is determined that the assisting operation is unnecessary (step S7: NO), the movement assisting device 10 terminates the assisting operation for the corresponding or current execution timing. On the other hand, if it is determined that the assisting operation is necessary (step S7: YES), then the control proceeds to the next step (step S8).

In step S8, the assistance control ECU 12 implements in the user's own vehicle 60 a process directed to the target object, by controlling the assisting operations performed by the assisting unit 50. Prior to implementing such a control, the assistance signal generating unit 18 generates assistance signals (e.g., control amounts) that are used for the controls of the assisting unit 50, and thereafter, outputs the assistance signals to the assisting unit 50.

The ECU 36 causes the non-illustrated accelerator pedal to rotate by supplying a drive signal indicative of an accelerator control amount to the accelerator actuator 46. The ECU 37 causes the non-illustrated brake pedal to rotate by supplying a drive signal indicative of a brake control amount to the brake actuator 47. The ECU 38 causes the non-illustrated steering wheel to rotate by supplying a drive signal indicative of a steering control amount to the steering actuator 48.

In this manner, the movement assisting device 10 executes appropriate controls to control the acceleration, deceleration, stopping, or steering of the user's own vehicle 60, whereby following (following control) of the vehicle that is the target object, or maintaining a distance interval (inter-vehicle control) between the vehicle and the user's own vehicle 60 is implemented. The types of movement assistance are not limited to an ACC (Adaptive Cruise Control), and for example, may involve a “contact avoidance control” for avoiding contact with the other physical object, and a “collision alleviating control” for alleviating a collision when contact with the other physical object takes place.

Further, in combination with or separately from each of the aforementioned types of controls, the movement assisting device 10 may output visual information (or speech sound information), which indicates the presence of a target object, to the touch panel display 42 (or the speaker 43), thereby prompting the driver or occupant of the user's own vehicle 60 to take an action for driving.

In this manner, the movement assisting device 10 brings the assisting operation of one execution timing to an end. The movement assisting device 10 carries out an operation sequence following the flowchart of FIG. 3, at the same or in different time intervals, whereby target objects are set by sequentially detecting the other physical objects that reside in the vicinity of the user's own vehicle 60 during traveling, and as necessary, processing in relation to the target objects is implemented in the user's own vehicle 60.

### [Method of Detecting Other Physical Objects]

Next, a method of detecting other physical objects (step S3 of FIG. 3) will be described in detail with reference to the flowchart of FIG. 4.

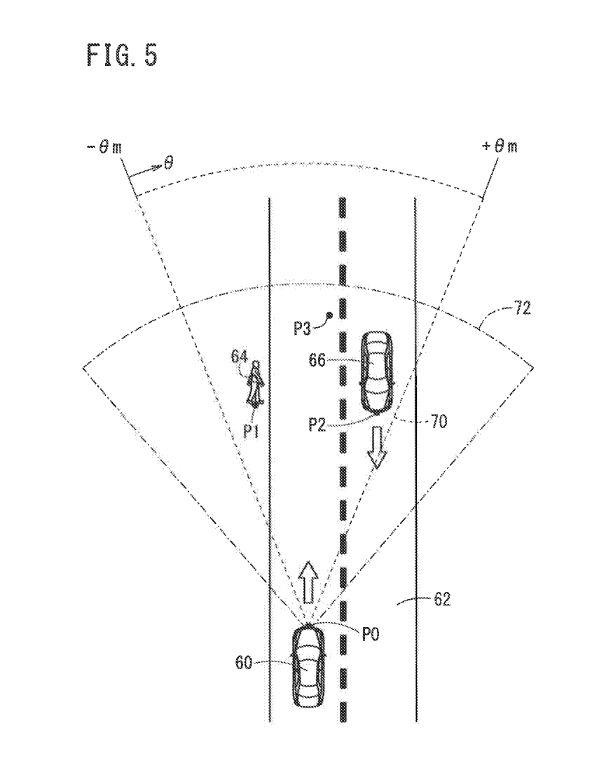

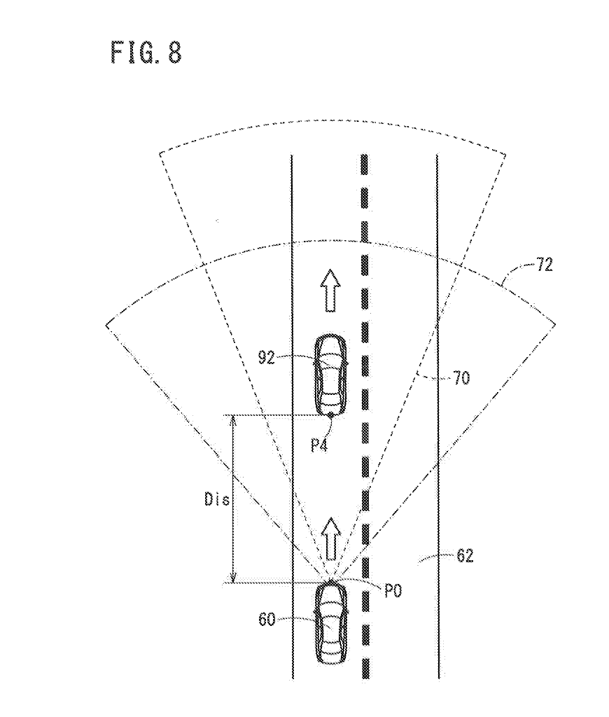

FIG. 5 is a first plan view showing a positional relationship between the user's own vehicle 60 and another physical object. The state of a road 62 shown in FIG. 5 and in FIG. 8, to be described later, applies to countries or regions in which automobiles are legally required to stay on the left side of the road.

The user's own vehicle 60 is traveling in a left lane of the road 62 which is in the form of a straight line. In front of the user's own vehicle 60, a pedestrian 64 is present who is attempting to cross the road 62. In the vicinity of the pedestrian 64, another vehicle 66 is present that is traveling in a right lane of the road 62. In this instance, the positions of the user's own vehicle 60, the pedestrian 64, and the other vehicle 66 are defined respectively as actual positions P0, P1, and P2.

The fan-shaped region surrounded by the dashed lines represents a region (hereinafter referred to as a first detection range 70) in which other physical objects are capable of being detected by the radar sensor 26 alone. Further, the fan-shaped region surrounded by the one-dot-dashed lines represents a region (hereinafter referred to as a second detection range 72) in which other physical objects are capable of being detected by the camera 28 alone. In the foregoing manner, it should be kept in mind that the radar sensor 26 employs a detection method having a higher distance detection accuracy and a greater detection upper limit value than the camera 28.

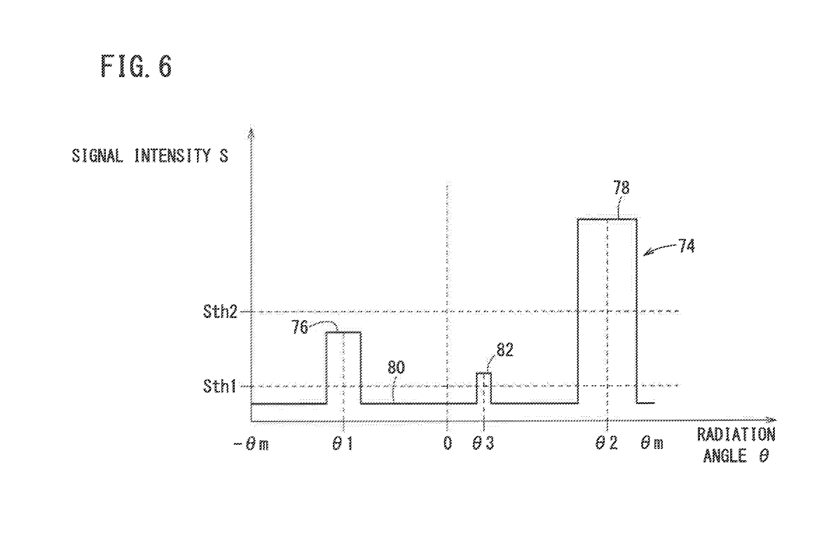

In step S31, the first detecting unit 20 executes a first detection process with respect to the first detection signal that was acquired in step S1 (see FIG. 3). A specific example of the first detection process will be described with reference to FIGS. 5 and 6.

In FIG. 5, as variables that specify the positions within the first detection range 70, radiation angles θ (unit: deg) are defined therefor. The radiation angles θ are angles of inclination with respect to the axial direction of the user's own vehicle 60, in which clockwise is taken as a positive direction and counterclockwise is taken as a negative direction. The first detection range 70 is assumed to encompass a range of −θm≦θ≦θm (where θm is a positive value of 25°, for example).

FIG. 6 is a schematic diagram showing radiation angle characteristics of a first detection signal. The horizontal axis of the graph in the present illustration represents the radiation angle θ (units: deg), whereas the vertical axis of the graph represents the signal intensity S (units: arbitrary). The implication is that the reflected waves are stronger as the value of the signal intensity S increases, and the reflected waves are weaker as the value of the signal intensity S decreases. More specifically, in the case that the distances from the radar sensor 26 are equal, there is a tendency for the signal intensity S to become greater for materials (e.g., metals) for which the reflection rate is high, and for the signal intensity S to become smaller for materials (e.g., fibers or textiles) for which the reflection rate is low.

Conversely, for radiation angles θ at which other physical objects do not exist, the signal intensity S is zero (or of a negligibly small value). Similarly, even if the inequality θ≦|θm| is satisfied, for physical objects that reside outside of the first detection range 70, the signal intensity S is zero (or a negligibly small value).

Under the obtained positional relationship shown in FIG. 5, signal characteristics 74 correspond to the reflection angle characteristics of the first detection signal. The signal characteristics 74 include two large detection levels 76 and 78. Either one of the detection levels 76, 78 is significantly greater than the average noise signal (hereinafter referred to as an average noise level 80) from the external environment.

Initially, the first detecting unit 20 analyzes the signal characteristics 74 using an optional analysis technique, and acquires the detection level 76 corresponding to the pedestrian 64 (see FIG. 5), and the detection level 78 corresponding to the other vehicle 66 (see FIG. 5). More specifically, the first detecting unit 20 extracts signal components for which the signal intensity S thereof is greater than a first threshold value Sth1, and thereby acquires, respectively, the detection level 76 corresponding to a radiation angle θ1, and the detection level 78 corresponding to a radiation angle θ2.

In this instance, the first detecting unit 20 may determine the type of the other physical object, on the basis of microscopic features (the height, width, and variance of the levels) of the detection levels 76, 78. For example, using the point that the other vehicle 66 is constituted by a material (principally metal) having a relatively high electromagnetic wave reflection rate, the first detecting unit 20 may recognize that the type of the other physical object for which the detection level 78 thereof is relatively high is a “vehicle”.

The signal characteristics 74 shown in FIG. 6 include another detection level 82 apart from the aforementioned detection levels 76 and 78. The detection level 82 is a sporadic noise signal caused by some sort of external disturbance factor, which is significantly greater than the average noise level 80. As a result, the first detecting unit 20 acquires not only the detection levels 76, 78 indicative of the presence of other physical objects, but acquires along therewith the detection level 82 which is greater than the first threshold value Sth1. Below, to facilitate description thereof, the other physical objects that correspond to the detection levels 76, 78, and 82 will be referred to as “other physical object A1”, “other physical object B1”, and “other physical object C1”.

Next, the first detecting unit 20, using the radiation angle θ=θ1, the detection level 76, and the delay time, calculates the actual position P1 of the “other physical object A1” by a geometric calculation method. In a similar manner, the first detecting unit 20 calculates the respective actual positions P2, P3 of the “other physical object B1” and the “other physical object C1”. Further, the first detecting unit 20 determines displacement amounts from the calculation results of the previous execution timing, and by dividing the displacement amounts by a given time interval, the movement speeds of the other physical objects A1, etc., are calculated in conjunction therewith.

In step S32, the accuracy determining unit 22 determines whether or not the detection accuracy of the other physical objects is high, based on the detection result obtained in step S31. More specifically, the accuracy determining unit 22 makes a determination on the basis of a magnitude relationship between each of the detection levels 76, 78, 82 and the second threshold value Sth2 (>Sth1).

In the example shown in FIG. 6, the detection level 78 is greater than the second threshold value Sth2, and therefore, the accuracy determining unit 22 determines that the detection accuracy of the other physical object corresponding to the other vehicle 66 is high (step S32: YES), whereupon the control proceeds to step S33.

In step S33, the other physical object detecting unit 14 determines as a candidate for the target object the “other physical object B1” (the other vehicle 66 in the example of FIGS. 5 and 6) for which it was determined in step S32 that the detection accuracy is high. In addition, the other physical object detecting unit 14 supplies to the target object setting unit 17 detection information (for example, type and position information) in relation to the target object candidate.

On the other hand, in the example shown in FIG. 6, the detection level 76 is less than or equal to the second threshold value Sth2, and therefore, the accuracy determining unit 22 determines that the detection accuracy of the other physical object corresponding to the other vehicle 66 is low. Similarly, the detection level 82 is less than or equal to the second threshold value Sth2, and therefore, the accuracy determining unit 22 determines that the detection accuracy of the other physical object (which is actually non-existent) is low. In such cases (step S32: NO), the control proceeds to step S34.

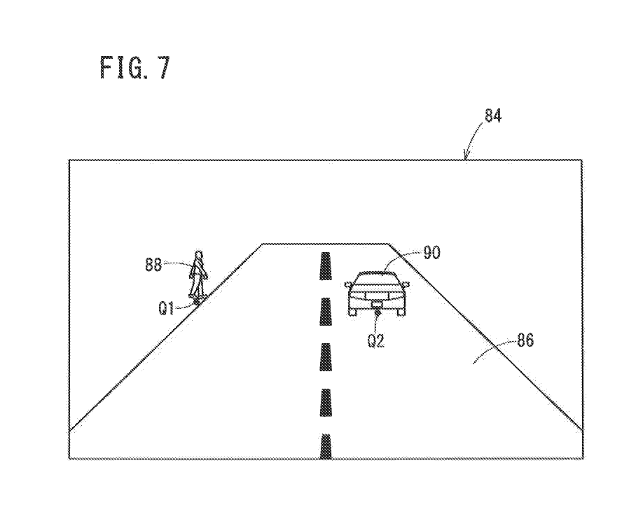

In step S34, the second detecting unit 21 executes a second detection process with respect to the second detection signal that was acquired in step S2 (see FIG. 3). A specific example of the second detection process will be described with reference to FIG. 7.

FIG. 7 is a schematic diagram showing a captured image 84 in a second detection signal. In the captured image 84, there exist, respectively, a road region 86 that is a projected image of the road 62, a human body region 88 that is a projected image of the pedestrian 64, and a vehicle region 90 that is a projected image of the other vehicle 66.

Using a well-known image recognition method, the second detecting unit 21 identifies the human body region 88 and the vehicle region 90 that exist within the captured image 84. In addition, using the sensor signals supplied from the sensor group 30, the second detecting unit 21 calculates the actual positions P1 and P2 that correspond to the reference positions Q1 and Q2. Below, to facilitate description thereof, the other physical objects that correspond to the human body region 88 and the vehicle region 90 will be referred to as “other physical object A2” and “other physical object B2”.

The second detecting unit 21 acquires not only the positions of the other physical objects, but also acquires in conjunction therewith the speed, the width, and attributes (for example, the type, orientation, and the movement state) of the other physical objects.

In step S35, the same object identifying unit 23 identifies the sameness of the other objects that are specified respectively in the first detection signal and the second detection signal. More specifically, the same object identifying unit 23 identifies that the respective other objects are the “same object” in the case that the difference in the two sets of actual positions P1 to P3 that were calculated from both detection signals lie within an allowable range (for example, within 5 m), and that they are “not the same object” if the difference lies outside of the allowable range.

In the example shown in FIGS. 5 to 7, the actual position P1 of the “other physical object A1” specified from the radiation angle θ1 etc. is substantially equivalent to the actual position P1 of the “other physical object A2” specified from the reference position Q1 etc., and therefore the “other physical object A1” and the “other physical object A2” are identified as being the “same object”.

On the other hand, in relation to the actual position P3 specified from the radiation angle θ3 etc., there is no position (other physical object) that exists corresponding thereto within the captured image 84. In this case, since positions do not exist for which the difference therebetween lies within the allowable range, it is identified that the “other physical object C1” is “not the same object” as either one of the other physical objects (“other physical object A2”, “other physical object B2”).

In step S36, on the basis of the identification result of step S35, the same object identifying unit 23 determines whether or not both of the other physical objects are the same object. If it is determined that they are the same object (step S36: YES), then the control proceeds to step S33.

In step S33, the other physical object detecting unit 14 determines as a candidate for the target object the “other physical object A1” (the pedestrian 64 in the example of FIGS. 5 and 6) for which it was determined in step S36 to be the same object. In addition, the other physical object detecting unit 14 integrates and fuses the detection information (position, speed) obtained in the first detection process, and the detection information (position, speed, width, attributes) obtained in the second detection process, and supplies the obtained detection information to the target object setting unit 17.

On the other hand, returning to step S36, in the case it is determined by the same object identifying unit 23 that the physical objects are not the same object (step S36: NO), then the detection process is directly brought to an end. Stated otherwise, the other physical object detecting unit 14 excludes the “other physical object C1” that was detected in step S31 (which is actually non-existent) from the target object candidates.

In this manner, the presence or absence and types of physical objects (specifically, pedestrians 64 and other vehicles 66) are detected by the other physical object detecting unit 14 (see step S3 of FIG. 3 and FIG. 4).

### [Modifications of Detection Method]

The other physical object detecting unit 14 may detect other objects using methods that differ from the above-described detection method. For example, in step S32 of FIG. 4, although the determination is made on the basis of a magnitude relationship between each of the detection levels 76, 78, 82 and the second threshold value Sth2, the determination may be made in accordance with different judgment conditions.

The first judgment condition is a condition in relation to the processing load. More specifically, the accuracy determining unit 22 may determine that the detection accuracy is high if an amount of data or an amount of computational processing of the first detection signal is more than a threshold value, and may determine that the detection accuracy is not high if the amount of data or the amount of computational processing of the first detection signal is less than or equal to the threshold value. By this feature, a trend is suitably reflected in which the detection accuracy becomes higher the greater the amount of data or the amount of computational processing of the first detection signal.

The second judgment condition is a temporal condition in relation to the detection result. More specifically, the accuracy determining unit 22 may determine that the detection accuracy is high if a duration over which the other physical object is specified by the first detection signal is longer than a threshold value, and may determine that the detection accuracy is not high if the duration over which the other physical object is specified by the first detection signal is less than or equal to the threshold value. By this feature, a trend is suitably reflected in which the detection accuracy becomes higher the longer the duration is over which the other physical object is specified by the first detection signal.

The third judgment condition is a condition in relation to the pattern possessed by the first detection signal. More specifically, the accuracy determining unit 22 may determine whether or not the detection accuracy is high on the basis of a correlation value between a pattern signal and the first detection signal or a time series of the first detection signal. For example, a pattern signal (more specifically, a waveform distribution or a time transition characteristic) indicative of detection behavior of dropping or falling down of other physical objects can be used. By this feature, a trend can suitably be reflected in which the detection accuracy becomes low for cases in which the correlation value is high with a typical pattern signal that tends to result in erroneous detection.

Further, in step S33 of FIG. 4, although the second detection process (step S34) is implemented only with respect to other physical objects for which the detection accuracy is low, the second detection process may also be implemented with respect to other physical objects for which the detection accuracy is high. In addition, the other physical object detecting unit 14 may integrate the respective pieces of detection information obtained by the first detection process and the second detection process, and may obtain detection information of other physical objects for which the detection accuracy is high.

### [Detailed Examples of Assisting Operation]

Next, descriptions will be given with reference to FIG. 5 (contact avoidance control example) and FIG. 8 (inter-vehicle control example) concerning the behavior of the user's own vehicle 60, which is the recipient of the assisting operation of the assisting unit 50.

### First Example

As shown in FIG. 5, in front of the user's own vehicle 60, a pedestrian 64 is present who is attempting to cross the road 62. Under these conditions, in the assistance control ECU 12, it is determined that an avoidance operation is necessary, since there is a possibility for the user's own vehicle 60 to come into contact with the pedestrian 64. Thereafter, the user's own vehicle 60 copes with the pedestrian 64 by decelerating or stopping in a timely fashion. Further, in the case that the other vehicle 66 does not exist, the user's own vehicle 60 may cope with the pedestrian 64 by steering in a rightward direction. In this manner, a contact avoidance control can be realized by performing a control so that the user's own vehicle 60 does not come into contact with the other physical object.

### Second Example

FIG. 8 is a second plan view showing a positional relationship between the user's own vehicle 60 and another physical object. The user's own vehicle 60 is traveling in a left lane of the road 62 which is in the form of a straight line. In front of the user's own vehicle 60, another vehicle 92 exists that is traveling on the road 62 ahead of the user's own vehicle 60. In this situation, the distance between the actual position P0 of the user's own vehicle 60 and the actual position P4 of the other vehicle 92 is referred to as an inter-vehicle distance Dis.

Under these conditions, in the assistance control ECU 12, it is determined that it is necessary for the user's own vehicle 60 to travel while following the other vehicle 92. Thereafter, responsive to the speed of the other vehicle 92, the user's own vehicle 60 copes with the other vehicle 92 by accelerating and decelerating, depending on the speed of the other vehicle 92. In this manner, an inter-vehicle control (one form of an ACC control) can be realized by performing a control so that the inter-vehicle distance Dis falls within a predetermined range.

### Advantages of the Embodiment

As has been described above, the movement assisting device 10 is equipped with the radar sensor 26 that acquires the first detection signal indicative of another physical object (pedestrian 64, other vehicles 66, 92) that exists in the vicinity of the user's own vehicle 60, the camera 28 for acquiring a second detection signal indicative of the other physical object, and the assistance control ECU 12 that implements a process in the user's own vehicle 60 to cope with the other physical object, by controlling the operation of the assisting unit 50 based on the first detection signal and the second detection signal that are acquired respectively.

In addition, the assistance control ECU 12 comprises the accuracy determining unit 22 that determines whether or not the detection accuracy in accordance with the first detection signal is high, and the same object identifying unit 23 that identifies whether or not the other physical objects specified respectively by the first detection signal and the second detection signal are the same object, and furthermore, in the case it is determined that the detection accuracy is not high, the assisting operation is controlled only if it is identified that the other physical objects are the same object.

Since the movement assisting device 10 is configured in this manner, in a master-servant relationship in which the radar sensor 26 is regarded as the main (primary determination) member, and the camera 28 is regarded as the subordinate (secondary determination) member, the detection result of the other physical object can be determined in a multilateral and complementary manner. Consequently, in the case that the other physical object is detected based on the two types of detection signals, it is possible to continue the assisting operation with stabilized behavior, even under a condition in which the detection reliability of one of the detection signals is low.

Further, the accuracy determining unit 22 may determine that the detection accuracy is high if the detection level 78 is greater than the second threshold value Sth2, and may determine that the detection accuracy is not high if the intensity of the detection levels 76, 82 is less than or equal to the second threshold value Sth2. Even if the detection accuracy is determined erroneously to be high due to noise components of a degree that cannot be ignored (detection level 82) being mixed within the first detection signal, since it is identified by the same object identifying unit 23 that the objects are not the same, starting and continuation of the assisting operation due to false positives can be prevented.

### [Supplemental Features]

The present invention is not limited to the embodiment described above, and the embodiment may be changed or modified within a range that does not deviate from the essential gist of the present invention.

According to the present embodiment, although the radar sensor 26 is used as the first detecting member, a detection system (for example, an ultrasonic sensor) that makes use of radiation characteristics or reflection characteristics of energy may also be used. In relation thereto, concerning the accuracy determining unit 22, the calculation method and thresholds for the detection accuracy may be modified in various ways corresponding to the detection system. For example, if the first detecting member is a camera, the evaluation result therefrom may be scored by a plurality of image recognition techniques, and the detection accuracy may be calculated by means of a total score of such scorings.

According to the present embodiment, although the second detecting member (camera 28) employs a detection system that differs from that of the first detecting member (radar sensor 26), the same detection system may be used. Further, although a monocular camera 28 is used as the second detecting member, the second detecting member may be a multiocular camera (stereo camera). Alternatively, the second detecting member may be an infrared camera instead of a color camera, or may include both an infrared camera and a color camera in combination.

In the illustrated embodiment, the movement assisting device 10 is mounted entirely on the user's own vehicle 60. However, the movement assisting device 10 may be configured in other ways. For example, a configuration may be provided in which the first detection signal from the first detecting member and/or the second detection signal from the second detecting member, which are mounted on the user's own vehicle 60, may be transmitted via a wireless transmitting device to a separate processing device (including the assistance control ECU 12). Alternatively, a configuration may be provided in which the first and second detecting members are arranged in a fixed manner, and the other physical object is detected from outside of the user's own vehicle 60.

In the illustrated embodiment, the movement assisting device 10 is applied to a four-wheel vehicle (a vehicle in a narrow sense). However, the movement assisting device 10 can be applied to other mobile objects which are physical objects or living bodies (including human beings). Mobile objects to which the present invention may be applied include vehicles in a wide sense, such as bicycles, ships, aircrafts, artificial satellites, or the like, for example. In the case of mobile objects that are human beings, the movement assisting device 10 may be constituted more specifically by wearable devices including glasses, watches, and hats.

1. A movement assisting device including an assisting unit configured to assist movement of a physical object or a living body as a mobile object, comprising:
a first detecting member configured to acquire a first detection signal indicative of another physical object that exists in vicinity of the mobile object;
a second detecting member configured to acquire a second detection signal indicative of the other physical object, and to use a same or a different detection system as the first detecting member; and
an assistance control member configured to implement a process in the mobile object to cope with the other physical object, by controlling an assisting operation performed by the assisting unit based on the first detection signal and the second detection signal that are acquired respectively by the first detecting member and the second detecting member;
wherein the assistance control member includes:
an accuracy determining unit configured to determine whether or not detection accuracy in accordance with the first detection signal is high; and
a same object identifying unit configured to identify whether or not the other physical objects specified respectively by the first detection signal and the second detection signal are the same object;
wherein, in a case it is determined by the accuracy determining unit that the detection accuracy is greater than a predetermined value, the assisting operation is capable to be controlled based on only a detection result obtained from the first detecting member, and in a case it is determined by the accuracy determining unit that the detection accuracy is less than or equal to the predetermined value, the assisting operation is controlled only if it is further identified by the same object identifying unit that the other physical objects are the same object.

2. The movement assisting device according to claim 1, wherein the accuracy determining unit is configured to determine that the detection accuracy is high if an intensity of the first detection signal is greater than a threshold value, and determine that the detection accuracy is not high if the intensity of the first detection signal is less than or equal to the threshold value.

3. The movement assisting device according to claim 1, wherein the accuracy determining unit is configured to determine that the detection accuracy is high if an amount of data or an amount of computational processing of the first detection signal is more than a threshold value, and determine that the detection accuracy is not high if the amount of data or the amount of computational processing of the first detection signal is less than or equal to the threshold value.

4. The movement assisting device according to claim 1, wherein the accuracy determining unit is configured to determine that the detection accuracy is high if a duration over which the other physical object is specified by the first detection signal is longer than a threshold value, and determine that the detection accuracy is not high if the duration over which the other physical object is specified by the first detection signal is less than or equal to the threshold value.

5. The movement assisting device according to claim 1, wherein the accuracy determining unit is configured to determine whether or not the detection accuracy is high on a basis of a correlation value between a pattern signal and the first detection signal or a time series of the first detection signal.

6. The movement assisting device according to claim 1, wherein the first detecting member is configured to employ a detection system in which a detection accuracy of a distance between the mobile object and the other physical object is higher, together with a detection upper limit value of the distance being greater than that of the second detecting member.

7. The movement assisting device according to claim 6, wherein the first detecting member is constituted by a radar sensor, and the second detecting member is constituted by a camera.
